(19) United States
(12) Patent Application Publication
(10) Pub. No.: US 2020/0339134 A1
(43) Pub. Date: Oct. 29, 2020

(54) METHOD AND APPARATUS FOR DYNAMIC YAW RATE BIAS ESTIMATION

(71) Applicant: GM GLOBAL TECHNOLOGY OPERATIONS LLC, Detroit, MI (US)

(72) Inventors: Brandon C. Pennala, Howell, MI (US); Hualin Tan, Novi, MI (US); Daryl A. Wilson, Brighton, MI (US)

(73) Assignee: GM GLOBAL TECHNOLOGY OPERATIONS LLC, Detroit, MI (US)

(21) Appl. No.: 16/391,455

(22) Filed: Apr. 23, 2019

(51) Int. Cl. B60W 40/114; B60W 40/13

(52) U.S. Cl. CPC B60W 40/114; B60W 2050/0083; B60W 2040/1346; B60W 40/13

(57) ABSTRACT

The present application generally relates to a method and apparatus for generating an action policy for controlling an autonomous vehicle. In particular, the method and apparatus include a memory operative to store a map data, a sensor operative to provide a location, a yaw rate sensor operative to measure a yaw rate, a processor for receiving the yaw rate, and a processor for determining a yaw rate calibration bias in response to the yaw rate, the location, and the map data, and a vehicle controller for controlling a vehicle in response to the yaw rate calibration bias.

### BACKGROUND

The present disclosure relates generally to programming motor vehicle control systems. More specifically, aspects of this disclosure relate to systems, methods and devices for dynamic yaw rate bias determination using GPS location and high definition map data in order to compensate for yaw rate bias error.

The operation of modern vehicles is becoming more automated, i.e. able to provide driving control with less and less driver intervention. Vehicle automation has been categorized into numerical levels ranging from zero, corresponding to no automation with full human control, to five, corresponding to full automation with no human control. Various automated driver-assistance systems (ADAS), such as cruise control, adaptive cruise control, and parking assistance systems correspond to lower automation levels, while true “driverless” vehicles correspond to higher automation levels.

Adaptive cruise control systems have been developed where not only does the system maintain the set speed, but also will automatically slow the vehicle down in the event that a slower moving preceding vehicle is detected using various sensors, such as radar and cameras. Further, some vehicle systems attempt to maintain the vehicle near the center of a lane on the road. An important aspect of effective ADAS operation is determining an accurate yaw rate signal with improved bias error estimation for use in controlling a lane centering feature. It would be desirable to provide a more accurate yaw rate signal with improved bias error estimation for use in assisted driving control systems.

The above information disclosed in this background section is only for enhancement of understanding of the background of the invention and therefore it may contain information that does not form the prior art that is already known in this country to a person of ordinary skill in the art.

### SUMMARY

Disclosed herein are autonomous vehicle control system training systems and related control logic for provisioning autonomous vehicle control, methods for making and methods for operating such systems, and motor vehicles equipped with onboard control systems. By way of example, and not limitation, there is presented an automobile with onboard vehicle control learning and control systems.

In accordance with an aspect of the present invention, an apparatus having a memory operative to store a map data, a sensor operative to provide a location, a yaw rate sensor operative to measure a yaw rate, a processor for receiving the yaw rate, and determining a yaw rate calibration bias in response to the yaw rate, the location, and the map data, and a vehicle controller for controlling a vehicle in response to the yaw rate calibration bias.

In accordance with another aspect of the present invention the map data includes high definition map data received via a wireless network.

In accordance with another aspect of the present invention the sensor includes a global positioning system sensor.

In accordance with another aspect of the present invention having a first wheel speed sensor for measuring the wheel speed of a first wheel and a second wheel speed sensor for measuring the speed of a second wheel and wherein the processor is operative to determine the yaw rate calibration bias in response to the wheel speed of the first wheel equaling the wheel speed of the second wheel.

In accordance with another aspect of the present invention the memory is further operative to store the yaw rate calibration bias and the processor is further operative to couple the yaw rate calibration bias to the memory.

In accordance with another aspect of the present invention the processor is operative to determine the yaw rate calibration bias in response to the map data and the location being indicative of the vehicle traveling in a straight line.

In accordance with another aspect of the present invention the processor is operative to determine the yaw rate calibration bias in response to the map data and the location being indicative of the vehicle yaw rate of zero degrees per second.

In accordance with another aspect of the present invention a vehicular control system having a memory operative to store a map data, a location sensor operative to provide a current location of a vehicle, a steering control monitor operative to provide a current steering angle, a first wheel speed sensor for providing a left side wheel speed, a second wheel speed sensor for providing a right side wheel speed, a yaw rate sensor for providing a yaw rate, a processor for determining a straight path roadway in response to the map data and the current location of the vehicle, to confirm the straight path roadway in response to the current steering angle the left side wheel speed and the right side wheel speed, and to generate a yaw rate bias in response to the confirmation of the straight path roadway and the yaw rate, and a controller for controlling the vehicle in response to the yaw rate bias.

In accordance with another aspect of the present invention the straight path roadway is confirmed in response to the left side wheel speed being the same as the right side wheel speed.

In accordance with another aspect of the present invention the straight path roadway is confirmed in response to the current steering angle being zero degrees.

In accordance with another aspect of the present invention the yaw rate bias is indicative of the difference between the yaw rate and a theoretical straight path yaw rate.

In accordance with another aspect of the present invention the yaw rate bias is indicative of the difference between the yaw rate and a zero degree yaw rate.

In accordance with another aspect of the present invention the location sensor is a global positioning system sensor.

In accordance with another aspect of the present invention a method for controlling a vehicle including receiving a yaw rate measurement, comparing a first wheel speed and a second wheel speed, retrieving a map data and a location data in response to the first wheel speed equaling the second wheel speed, determining a path curvature in response to the map data and the location data, calculating a yaw rate bias in response to the yaw rate measurement and the path curvature, and controlling the vehicle in response to the yaw rate bias.

In accordance with another aspect of the present invention the path curvature is zero degrees.

In accordance with another aspect of the present invention the path curvature indicates the vehicle traveling in a straight line.

In accordance with another aspect of the present invention the yaw rate bias is further calculated in response to a steering angle change being equal to zero degrees over a first time duration.

In accordance with another aspect of the present invention the method further includes determining a steering angle change and wherein the yaw rate bias is determined in response to the steering angle change being zero degrees over a first time duration.

In accordance with another aspect of the present invention the yaw rate bias is used by an assisted driving algorithm.

In accordance with another aspect of the present invention the path curvature is indicative of a straight path of travel by the vehicle.

The above advantage and other advantages and features of the present disclosure will be apparent from the following detailed description of the preferred embodiments when taken in connection with the accompanying drawings.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings.

FIG. 1 shows an operating environment for dynamic yaw rate bias estimation for a motor vehicle according to an exemplary embodiment.

FIG. 2 shows a block diagram illustrating a system for dynamic yaw rate bias estimation for assisted driving according to an exemplary embodiment.

FIG. 3 shows a flow chart illustrating a method for dynamic yaw rate bias estimation for assisted driving according to another exemplary embodiment.

FIG. 4 shows a block diagram illustrating an exemplary implementation of a system for dynamic yaw rate bias estimation for assisted driving in a vehicle.

FIG. 5 shows a flow chart illustrating a method for dynamic yaw rate bias estimation for assisted driving according to another exemplary embodiment

The exemplifications set out herein illustrate preferred embodiments of the invention, and such exemplifications are not to be construed as limiting the scope of the invention in any manner.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

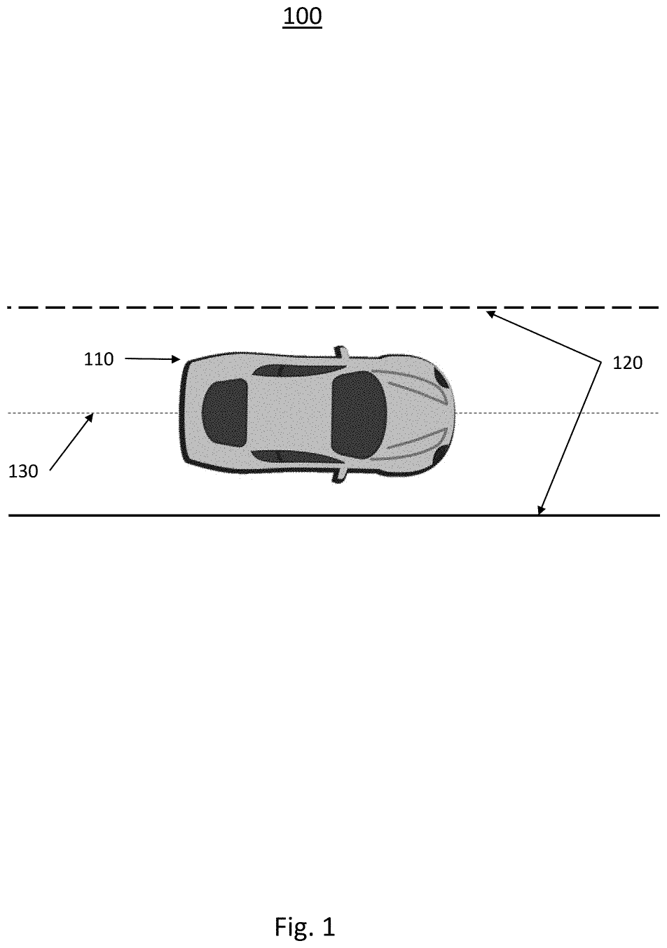

FIG. 1 schematically illustrates an operating environment for dynamic yaw rate bias estimation 100 for a motor vehicle 110. In this exemplary embodiment of the present disclosure, the vehicle is traveling along a road lane demarcated by lane markers 120. The vehicle 110 is operating in an assisted driving lane centering mode wherein the vehicle control system is operative to use cameras and other sensors to control the vehicle such that the vehicle stays in the center 130 of the driving lane. The exemplary vehicle 110 is further equipped with a map database and a global positioning system (GPS) sensor.

The vehicle 110 is operative to use at least one camera to capture images of at least a front field of view from the vehicle 110. The vehicle 110 is then operative to use image processing techniques on these images to detect the lane markers 120 on either side of the vehicle 110. These image processing techniques may include edge detection, Gabor filtering, deep learning and Hough transform. After detecting the lane markers 120, the vehicle 110 is operative to center itself between the lane markers 120 through use of the steering control algorithm. The lane centering path within may be represented as a series of lateral offsets, heading angles and longitudinal distances over a period of time. These longitudinal offsets are calculated in response to lateral speed, lateral position, and yaw rate. The yaw rate is the angular velocity of the rotation of the vehicle around its vertical axis.

Yaw rate is typically measured by either a piezoelectric sensor or a micromechanical sensor. These sensors have a certain amount of error which may change over time, so it is important to recalibrate the yaw rate output such that the correct lateral offsets are generated.

The disclosed methods can be used with any number of different systems and is not specifically limited to the operating environment shown here. The architecture, construction, setup, and operation of the system and its individual components is generally known. Other systems not shown here could employ the disclosed methods as well.

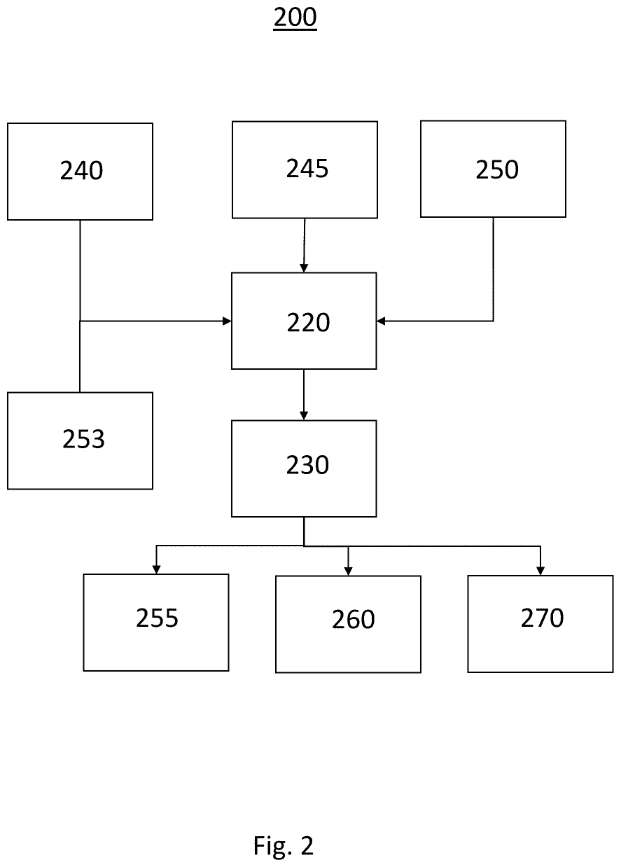

Turning now to FIG. 2, a block diagram illustrating an exemplary implementation of a system for dynamic yaw rate bias estimation for assisted driving 200 is shown. The system 200 includes a processor 220, such as a path processor, for receiving data from various vehicle sensors and generating a path for the vehicle. Among these sensors may be a yaw rate sensor 240 and a GPS sensor 245. In addition, the processor 220 may receive information such as map data 250 from a memory or the like, and user input via a user interface 253.

In the assisted driving system 200, the processor 220 may be operative to generate a desired path in response to a user input or the like wherein the desired path may include lane centering, curve following, lane changes, etc. This desired path information may be determined in response to the vehicle speed, the yaw angle and the lateral position of the vehicle within the lane. Once the desired path is determined, a control signal is generated by the processor 220 indicative of the desired path and is coupled to the vehicle controller 230. The vehicle controller 230 is operative to receive the control signal and to generate an individual steering control signal to couple to the steering controller 270, a braking control signal to couple to the brake controller 260 and a throttle control signal to couple to the throttle controller 255 in order to execute the desired path.

Dynamic yaw rate bias learn, which is deemed necessary for assisted driving systems, relies on accurate determination of straight driving condition. Methods to determine a straight driving condition may use left/right wheel speed difference and steering wheel angle to detect a driving straight condition. Alternatively, the method may be operative to compare the wheel speeds diagonally, such as left front and right rear. However, these methods may result in false detection of driving straight condition during long large radius curves. These false driving straight detection results in incorrect bias error learn and bias buildup in the yaw rate signal. For example, traveling at 100 kph on a banked roadway with an average yaw rate of approximately one degree per second is not robustly detectable using wheel speed or steering wheel angle, so traditional yaw rate bias learning algorithms can be “fooled” into learning a false bias in this case. The map and location data may be continuously retrieved, evaluated, and stored even if the wheel speed based driving straight detection is not satisfied on a given control loop. GPS location history and map curvature can be used to determine that the vehicle is in fact in a very slight curve and prevent the yaw rate bias under these conditions. An alternate to calculating path curvature would be to calculate GPS heading and look for GPS heading to be constant within a calibratable band.

GPS location history and high definition map data may be used to confirm the vehicle has been driving straight, and hence is in a condition where the yaw rate signal can be evaluated and adjusted for bias error. In an exemplary embodiment, the processor 220 is operative to receive new high definition map data from the map data memory 250 and location data from the GPS 245 to determine a highly accurate straight driving condition used for sensor bias learning. The processor 220 is then operative to calibrate the yaw rate signal using this sensor bias learning. The increased accuracy in yaw rate signal used for control in lane centering operations results in improved bias error estimation.

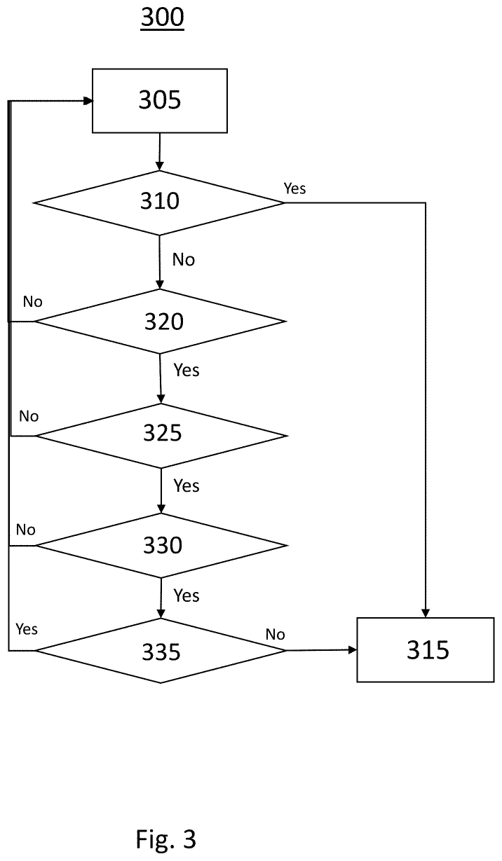

Turning now to FIG. 3, a flow chart illustrating an exemplary implementation of a method for dynamic yaw rate bias estimation for assisted driving 300 is shown. Yaw rate is a critical component in vehicle dynamics sensing where the actual value may be influenced by sensor bias. It is critical that the sensor bias be estimated and that the yaw rate be corrected in response to this bias. In order to correct the erroneous yaw rate signal and estimate the sensor bias the method is first operative to determine a need to update the yaw rate bias 305. This need may arise from a requirement to update the yaw rate bias periodically or may result from another operational requirement. The method is then operative to determine if the vehicle is stationary 310. If the vehicle is stationary, the method is then operative to update the yaw rate bias 315. A stationary vehicle will have a zero degree yaw rate as no there is no angular velocity around the vertical axis of the vehicle. If the vehicle is not stationary, such as on long highway trips, the method is operative to determine if the left and right wheel speeds match 320. If the wheel speeds do not match, indicating that the vehicle is in a turn, the method is operative to return to determining the need to update the yaw rate bias 305.

If the wheel speeds match 320, indicative of the vehicle traveling in a straight line, the method is then operative to determine if the vehicle location history and map data indicate that the vehicle is traveling in a straight line 325. For example, the vehicle location history may be superimposed over the high definition map data to determine which road the vehicle is traveling on and whether that road is a straight path suitable for yaw rate bias determination. It may be indicative in the map data that the stretch of road is a straight path suitable for yaw rate determination. Alternatively, the method may be operative to determine if the vehicle location history corresponds to a roadway, indicating a valid vehicle location history, and then the method may use a mathematical algorithm to determine if the discrete vehicle location points correspond to a straight path. If the GPS and map history indicate that the vehicle has not followed a straight path, or that the vehicle is in a turn, the method is operative to return to determining the need to update the yaw rate bias 305.

If the GPS and map history indicate that the vehicle is traveling in a straight line, the method is operative to determine that the map curvature is zero for a predetermined distance, such as 100 meters ahead and behind the vehicle 330. If the map curvature is not zero for the predetermined distance the method is operative to return to determining the need to update the yaw rate bias 305.

If the map curvature is zero over the predetermined distance, the method is then operative to determine if the steering angle change has occurred over a predetermined time period 335 such as one second. The method may be operative to monitor a steering angle indicator of a steering controller. If the steering angle has not changed significantly during a predetermined duration of time, the method may assume that the vehicle is traveling on a straight path. A small amount of steering degree change may be the result of lane keeping corrections or corrections resulting from environmental conditions, such as uneven road surface or wind. If the amount of steering angle is below a predetermined threshold amount, the method may still be operative to determine that the vehicle is traveling on a straight path. If the steering angle has changed during the predetermined time the method is operative to return to determining the need to update the yaw rate bias 305.

If the steering angle has not changed over the predetermined time period 335, the method is then operative to update the yaw rate bias 315. The current measured yaw rate can be received from a yaw rate sensor. This current measured yaw rate is then compared to the theoretical straight path yaw rate. The difference between these two rates becomes the yaw rate bias. This yaw rate bias is added to the current measured yaw rate in order to calibrate the yaw rate sensor such that the calibrated yaw rate is equal to the theoretical straight path yaw rate when the vehicle is traveling a straight path. Once the yaw rate bias has been updated, the method is then operative to return to determining the need to update the yaw rate bias 305.

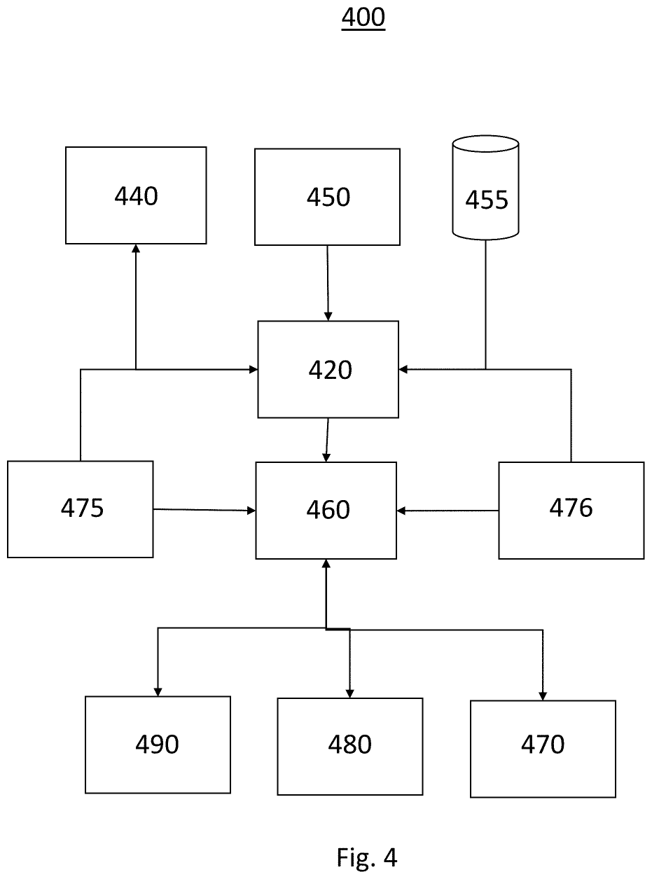

Turning now to FIG. 4, a block diagram illustrating an exemplary implementation of a system for dynamic yaw rate bias estimation for assisted driving 400 in a vehicle is shown. The system 400 may include a processor 420, a yaw rate sensor 440, a GPS sensor 450, a memory 455, a vehicle controller 460, a steering controller 490, a throttle controller 480, and a braking controller 470.

The yaw rate sensor 440 is operative to measure a rate of rotation of a vehicle around a vertical axis. For example a vehicle turning to the right may have a yaw rate of 5 degrees per second. The yaw rate sensor 440 may be part of an inertial measurement unit (IMU) or may be an independent device. The output of the yaw rate sensor 440 may be an oscillating voltage proportional in frequency or amplitude to the yaw rate.

The GPS sensor 450 receives a plurality of time stamped satellite signals including the location data of the transmitting satellite. The GPS then uses this information to determine a precise location of the GPS sensor 450. The processor 420 may be operative to receive the location data from the GPS sensor 450 and store this location data to the memory 455 along with a time stamp such that the path of the vehicle over time may be determined.

In an exemplary embodiment, the processor 420 is operative to monitor the stored location data and determine if the vehicle path is a straight line. The determination of a straight line path may be made in comparison of the location data and the map data. If the vehicle path is determined to be a straight line, the processor is operative to receive map data from the memory 455 and to determine the curvature of the current road surface for a distance before and after the current vehicle location. The processor 420 may then be operative to confirm the straight line path in response to a road curvature of zero degrees. The processor 420 may then receive data from the vehicle controller indicative of the steering angle received from the steering controller 490. The steering control data may be indicative of a sufficiently small change in the steering angle for a period of time, which may be further indicative that the vehicle is traveling in a straight line. Using any of these straight path indicators, the processor 420 may determine that the vehicle is traveling in a straight line and then update the yaw rate bias in response to this determination. The yaw rate bias is determined in response to the difference between the current yaw rate provided by the yaw rate sensor 440 and the straight line yaw rate value. This difference may be used as a bias value for calibration of the yaw rate sensor 440. The calibrated yaw rate value may then provided to the vehicle controller 460 for use in generating vehicle control signals for coupling to the steering controller 490, throttle controller 480, and braking controller 470.

In another exemplary embodiment, the memory 455 is operative to store high definition map data. The GPS sensor 450 is operative to provide a location and the yaw rate sensor 440 operative to measure a yaw rate. The processor 420 is then operative to receive the yaw rate and determine a yaw rate calibration bias in response to the yaw rate, the location, and the map data when the location and map data indicate the vehicle is traveling in a straight line path and therefore the estimated yaw rate is zero. The processor 420 is further operative to generate a control signal in response to the yaw rate calibration bias provide this yaw rate calibration bias to the vehicle controller 460 for controlling a vehicle in response to the yaw rate calibration bias.

The processor 420 may receive one or more wheel speeds from a wheel speed sensor 475 and use these wheel speeds to estimate when the vehicle is traveling in a straight path. For example, the system 400 may include a first wheel speed sensor 475 for measuring the wheel speed of a first wheel and a second wheel speed sensor 476 for measuring the speed of a second wheel and wherein the processor 420 is operative to determine a straight path driving condition in response to the wheel speed of the first wheel being approximately equal to the wheel speed of the second wheel. The processor 420 may then be operative to calculate and couple the yaw rate calibration bias to the memory 455 wherein the memory 455 is operative to store the yaw rate calibration bias. The vehicle controller 460 may then be operative to retrieve the yaw rate calibration bias from the memory 455.

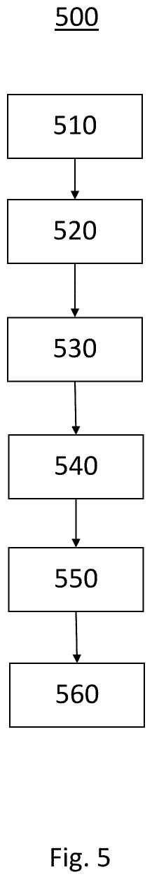

Turning now to FIG. 5, a flow chart illustrating an exemplary implementation of a system for dynamic yaw rate bias estimation for assisted driving 500 in a host vehicle is shown. In this exemplary embodiment the method 500 may be performed by a vehicle control system in an advanced driver assisted system equipped vehicle. The method is first operative to receive a yaw rate measurement 510 from an inertial measurement unit, yaw rate sensor, or the like. The method is then operative to receive a first wheel speed from a wheel on the left side of the vehicle and a second wheel speed from a wheel on the right side of the vehicle. The method is then operative to compare the first wheel speed and the second wheel speed to estimate if the vehicle is traveling in a straight path 520. If the wheel speeds are the same, within the level of accuracy of the wheel speed sensors, it can be assumed that the vehicle is traveling in a straight path. The wheel speeds may be monitored over a period of time to determine if any significant differences have occurred, indicating a vehicle turn had taken place. Additionally, the method may be operative to monitor the steering control angle to determine if any turns have been made over a period of time 530. A significant change in the steering control angle may be indicative of a vehicle turn. Small changes in the steering control angle may be indicative of a lane centering correction on a straight road and therefore insignificant changes in steering control angle may be disregarded. A steering angle change being equal to zero degrees over a first time duration may be indicative of a straight vehicle path.

If the wheel speeds are the same and the steering control angle does not indicate a turn, the method may then be operative to confirm the straight path by retrieving high definition map data from a memory and a location data from a global positioning system to confirm that path of the vehicle in in a straight roadway 540. This may be confirmed by determining that the current roadway is straight for a distance ahead and behind the current location of the vehicle. For instance, 100 meters before and after the current location of the vehicle may be chosen as the threshold distance of straight roadway to determine that the roadway is currently straight.

In response to the road surface being determined straight, the method is then operative to calculate a yaw rate bias in response to the yaw rate measurement and the path curvature 550. For example, if the vehicle is assumed to be traveling a straight path in a straight roadway, the estimated yaw rate should be zero degrees. The difference between the yaw rate provided by the yaw rate sensor and the estimated yaw rate is the yaw rate bias, or the amount that the yaw rate sensor output differs from the estimated yaw rate. This yaw rate bias is then used as a calibration factor applied the yaw rate sensor output to generate a corrected yaw rate. This corrected yaw rate is then coupled to the vehicle control system 560 for use in the advanced driver assisted system for controlling the vehicle

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An apparatus comprising:
a memory operative to store a map data;
a sensor operative to provide a location;
a yaw rate sensor operative to measure a yaw rate;
a processor for receiving the yaw rate and determining a yaw rate calibration bias in response to the yaw rate, the location, and the map data; and
a vehicle controller for controlling a vehicle in response to the yaw rate calibration bias.

2. The apparatus of claim 1 wherein the map data comprises high definition map data received via a wireless network.

3. The apparatus of claim 1 wherein the sensor comprises a global positioning system sensor.

4. The apparatus of claim 1 further comprising a first wheel speed sensor for measuring the wheel speed of a first wheel and a second wheel speed sensor for measuring the speed of a second wheel and wherein the processor is operative to determine the yaw rate calibration bias in response to the wheel speed of the first wheel equaling the wheel speed of the second wheel.

5. The apparatus of claim 1 wherein the memory is further operative to store the yaw rate calibration bias and the processor is further operative to couple the yaw rate calibration bias to the memory.

6. The apparatus of claim 1 wherein the processor is operative to determine the yaw rate calibration bias in response to the map data and the location being indicative of the vehicle traveling in a straight line.

7. The apparatus of claim 1 wherein the processor is operative to determine the yaw rate calibration bias in response to the map data and the location being indicative of the vehicle yaw rate of zero degrees per second.

8. A vehicular control system comprising:
a memory operative to store a map data;
a location sensor operative to provide a current location of a vehicle;
a steering control monitor operative to provide a current steering angle;
a first wheel speed sensor for providing a left side wheel speed;
a second wheel speed sensor for providing a right side wheel speed;
a yaw rate sensor for providing a yaw rate;
a processor for determining a straight path roadway in response to the map data and the current location of the vehicle, to confirm the straight path roadway in response to the current steering angle the left side wheel speed and the right side wheel speed, and to generate a yaw rate bias in response to the confirmation of the straight path roadway and the yaw rate; and
a controller for controlling the vehicle in response to the yaw rate bias.

9. The vehicular control system of claim 8 wherein the processor is further operative to confirm the straight path roadway in response to the left side wheel speed being the same as the right side wheel speed.

10. The vehicular control system of claim 8 wherein the processor is further operative to confirm the straight path roadway in response to the current steering angle having a mean angle of zero degrees.

11. The vehicular control system of claim 8 wherein the yaw rate bias is indicative of the difference between the yaw rate and a theoretical straight path yaw rate.

12. The vehicular control system of claim 8 wherein the yaw rate bias is indicative of the difference between the yaw rate and a zero degree yaw rate.

13. The vehicular control system of claim 8 wherein the location sensor comprises a global positioning system sensor.

14. A method for controlling a vehicle comprising:
receiving a yaw rate measurement from a yaw rate sensor;
comparing a first wheel speed from a first wheel speed sensor and a second wheel speed from a second wheel speed sensor;
retrieving a map data from a memory and a location data from a location sensor in response to the first wheel speed equaling the second wheel speed;
determining a path curvature in response to the map data and the location data;
calculating a yaw rate bias in response to the yaw rate measurement and the path curvature; and
controlling the vehicle with a vehicle controller in response to the yaw rate bias.

15. The method for controlling a vehicle of claim 14 wherein the path curvature is less than 0.1 meters.

16. The method for controlling a vehicle of claim 14 wherein the path curvature indicates the vehicle traveling in a straight line.

17. The method for controlling a vehicle of claim wherein the yaw rate bias is further calculated in response to a steering angle change having a mean angle of zero degrees over a first time duration.

18. The method for controlling a vehicle of claim 14 further comprising determining a steering angle change and wherein the yaw rate bias is determined in response to the steering angle having a mean angle of zero degrees over a first time duration.

19. The method for controlling a vehicle of claim 14 wherein the yaw rate bias is used by an assisted driving algorithm.

20. The method for controlling a vehicle of claim 14 wherein the path curvature is indicative of a straight path of travel by the vehicle.
